(19) United States
(12) Patent Application Publication
(10) Pub. No.: US 2014/0372273 A1
(43) Pub. Date: Dec. 18, 2014

(54) Automated Book-Entry Exchange of Futures for Interest Rate Swap (EFS) at Implied Current Coupon

(71) Applicant: CHICAGO MERCANTILE EXCHANGE, INC., Chicago, IL (US)

(72) Inventors: John Labuszewski, Westmont, IL (US); Richard Co, Chicago, IL (US); John Nyhoff, Darien, IL (US); Lori Aldinger, Naperville, IL (US); Daniel Grombacher, Evanston, IL (US)

(21) Appl. No.: 13/918,334

(22) Filed: Jun. 14, 2013

(51) Int. Cl. G06Q 40/04

(52) U.S. Cl. CPC G06Q 40/04
USPC 705/37

(57) ABSTRACT

Systems and methods are provided for liquidating existing deliverable swap futures contracts, such as deliverable interest rate swap futures contracts. An exchange determines non-par prices for existing deliverable swap futures contracts using estimates for future floating interest rate as selected by the exchange. The prices are listed and traders may submit notices of intention to liquidate existing deliverable swap futures contracts. The exchange matches notices and clears matched notices.

### FIELD OF THE INVENTION

The present invention relates to the processing of deliverable swap futures contracts, in particular, to methods and systems for liquidating deliverable swap futures contracts.

### DESCRIPTION OF THE RELATED ART

Swaps are often used to hedge certain risks, for instance, interest rate risk, but can also be used for speculative purposes. An interest rate swap (IRS) is an example of a type of swap product where the parties agree to exchange streams of future interest payments based on a specified principal or notional amount. Each stream may be referred to as a leg. When an IRS occurs at “par value,” no money changes hands between the counterparties, at the inception of the swap transaction, because the net present value (NPV) of the fixed and floating rates are equal at the time of the trade.

An example of a swap includes a plain fixed versus floating, or “vanilla,” interest rate swap. The vanilla swap includes an exchange of interest streams where one stream is based on a floating rate and the other interest stream is based on a fixed rate. In a vanilla swap, one party makes periodic interest payments to the other based on a variable interest rate, subject to periodic resets. The variable rate may be linked to a periodically known or agreed upon rate for the term of the swap such as the London Interbank Offered Rate (LIBOR) or the British Banker's Association (BBA) 3-month time deposit rate.

In return for the stream of payments based on the variable rate, the other party may receive periodic interest payments based on a fixed rate. The payments are calculated based on a designated notional amount. The first rate is called variable, because it is reset at the beginning of each interest calculation period to the then current reference rate, such as the LIBOR published rate. The counterparties may use an IRS to limit, or manage, exposure to fluctuations in interest rates, and/or to obtain lower interest rates than are otherwise available. Other examples of swaps include total return swaps, and equity swaps.

It is common for swaps, such as interest rate swaps, to have unique terms specified by the parties. While providing flexibility, unique terms can complicate valuation determinations and contribute to reducing liquidity of the swaps.

Therefore, there is a need in the art for improved systems and methods for improving the liquidity of swaps.

### SUMMARY OF THE INVENTION

Embodiments of the present invention overcomes problems and limitations of the prior art by providing systems and methods for liquidating existing deliverable swap futures contracts. An exchange or other entity determines non-par prices for existing deliverable swap futures contracts. The existing deliverable swap futures contracts may include deliverable interest rate swap futures contracts. The prices may be determined using a floating interest rate selected by an exchange and determined to be fair to both parties. The prices are listed and traders may submit notices of intention to liquidate existing deliverable swap futures contracts. An exchange may match notices and clear matched notices.

In other embodiments, embodiments of the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention;

FIG. 2 illustrates a system that may be used to liquidate deliverable swap futures contracts, such as deliverable interest rate swap futures contracts, in accordance with an embodiment of the invention;

FIG. 3 illustrates exemplary pricing data for a deliverable interest rate swap futures contract in accordance with an embodiment of the invention; and

FIG. 4 illustrates a method of processing deliverable swap futures contracts in accordance with an embodiment of the invention.

### DETAILED DESCRIPTION OF THE INVENTION

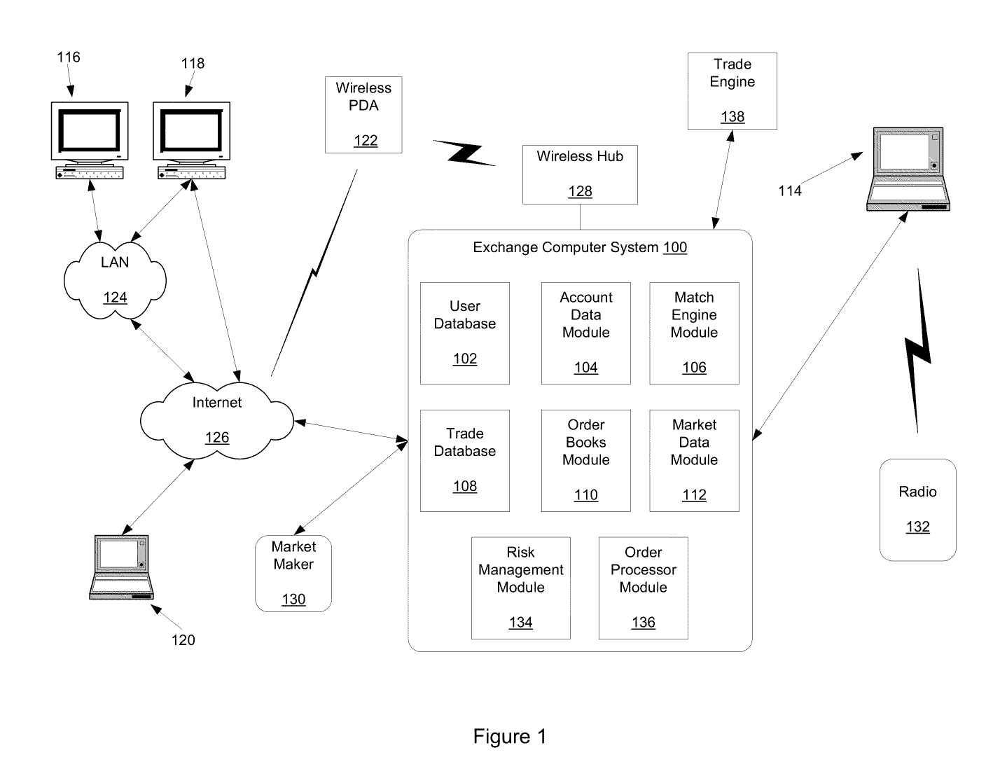

Aspects of the present invention may be implemented with computer devices and computer networks that allow users to exchange trading information. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords potentially with other information to identify users uniquely or collectively. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processor module 136 may be included to decompose variable defined derivative product and aggregate order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100.

Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems. Coupling can be direct as described or any other method described herein.

The operations of computer devices and systems shown in FIG. 1 may be controlled by computer-executable instructions stored on a computer-readable medium. Various computer-readable media that are tangible and non-transitory may be used. In one example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

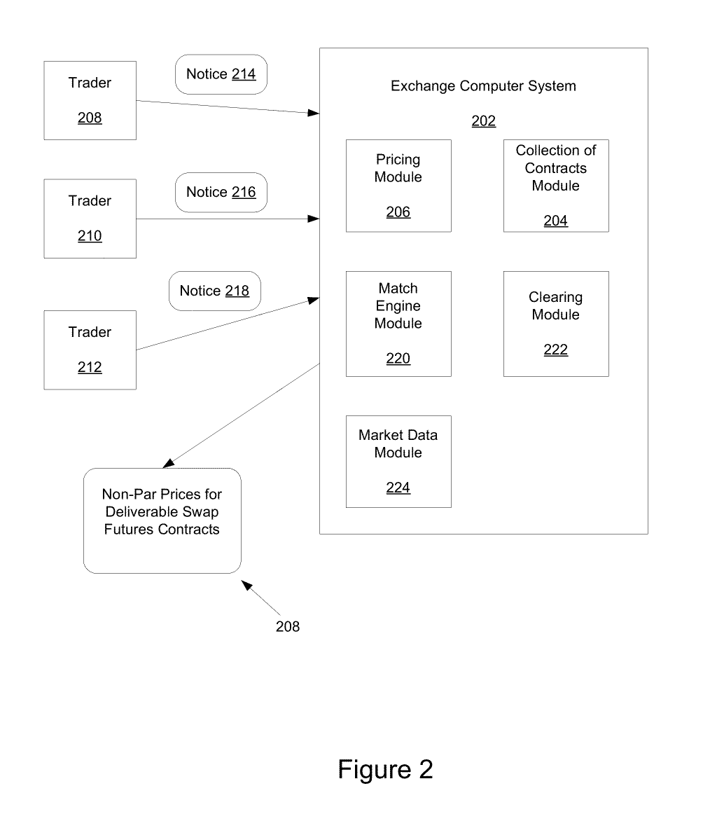

FIG. 2 illustrates a system that may be used to liquidate deliverable swap futures contracts, such as deliverable interest rate swap futures contracts, in accordance with an embodiment of the invention. A deliverable interest rate swap futures contract provides for the delivery of an interest rate swap (IRS) financial instrument. The financial instrument may be cleared through a clearing entity, such as an exchange clearing house. A deliverable interest rate swap futures contract may be based upon a “plain-vanilla” swap with a fixed coupon as established by an exchange and may be quoted in terms of the non-par value (NPV) of the delivered IRS. The quoted value may represent the present value of the stream of fixed rate payments minus the present value of the anticipated stream of floating rate payments.

Non-Par Value=PV(Fixed Rate Payments)−PV(Floating rate Payments) (equation 1)

Upon delivery, an invoice amount is paid in cash between buyer (fixed rate receiver or floating rate payer) and seller (fixed rate payer or floating rate receiver) of the futures contract. The invoice amount or cash adjustment reflects the NPV of the underlying swap instrument and may be identified by reference to a final settlement price of the DSF contract on the final trading day.

The system shown in FIG. 2 includes an exchange computer system 202. Exchange computer system 202 may be configured to liquidate existing deliverable interest rate swap futures contracts prior to delivery dates identified in the futures contracts. A collection of contracts module 204 may store details of existing deliverable swap futures contracts. The deliverable swap futures contracts may be deliverable interest rate swap futures contracts. A pricing module 206 may be used to determine non-par prices for existing deliverable swap futures contracts prior to delivery dates.

In various embodiments pricing module 206 may be configured to determine a non-par price by determining a difference between present value of the stream of fixed rate payments minus the present value of the anticipated stream of floating rate payments while using floating interest rate values set at fair values established by an exchange or other entity. Floating interest rate values may be set in accordance with prevailing market conditions and may be based on prevailing yields and forward yield curves. In one particular embodiment floating rate values correspond to published Eurodollar forward yield curves, such as the Bloomberg Eurodollar forward curve.

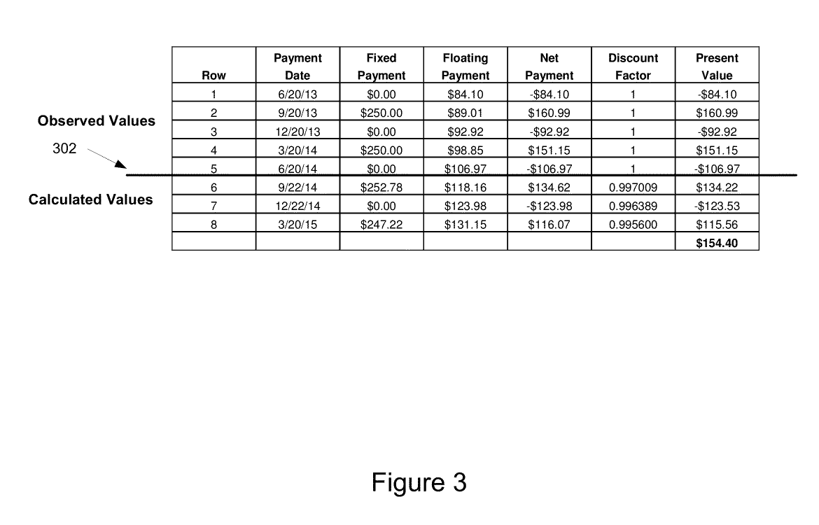

FIG. 3 illustrates exemplary pricing data for a two year deliverable interest rate swap futures contract having a fixed rate of 0.50% and a face value of $100,000. The floating rate may correspond to a LIBOR—based swap rate or some other rate. In the example shown, pricing module 206 may determine a non-par price after the Jun. 20, 2014 payment date and prior to the Sep. 22, 2014 payment date, for example. The data shown above line 302 may be based on observed data. In particular, the fixed interest rate was set and the floating interest has been observed, so the fixed payments, floating payments and net payments may be calculated. A discount factor may be used to account for the time value of the payments. Discount factors may be based upon LIBOR rates or upon the rates associated with overnight interest swap (OIS) instruments, along the spectrum of the yield curve, or upon other yield curves as deemed appropriate. In the embodiment shown, a discount factor of 1 is used for past payments. In other embodiments a discount factor greater than 1 may be used for past payments.

Fixed payments for payments beginning at Sep. 22, 2014 would also use the fixed interest rate identified in the deliverable interest rate swap futures contract. Floating payments may be calculated using a floating interest rate selected by an exchange or other entity. As described above, the floating rate may correspond to the published Eurodollar forward yield curve. Once any future floating rates are selected, floating payments, net payments and present values may be calculated. In the example shown the non-par value determined by pricing module 206 is $154.40. The non-par value may represent a value considered fair to both sides by an exchange or other entity.

After prices are calculated by pricing module 206, exchange computer system 202 may publish or otherwise distribute non-par prices for deliverable swap futures contracts 208. Traders 208, 210 and 212 may review the published information and transmit notices of intention to liquidate existing deliverable swap future contracts 214, 216 and 218. Some notices may include an identification of additional monetary consideration. For example, exchange computer system 202 may determine that a fair non-par for a given deliverable swap futures contract is $150 and trader 208 may be willing to liquidate his or her contract by paying $180. Notice 214 may correspondingly identify additional monetary consideration of $30.

Exchange computer system 202 may include a match engine module 220 configured to match notices received from traders. Exchange computer system 202 may also include a clearing module 222 configured to clear trades and a market data module 224 configured to generate and distribute market data. Exchange computer system may also include other modules shown in FIG. 1. The modules shown in exchange computer system 202 may be implemented with hardware, software or combinations of hardware and software.

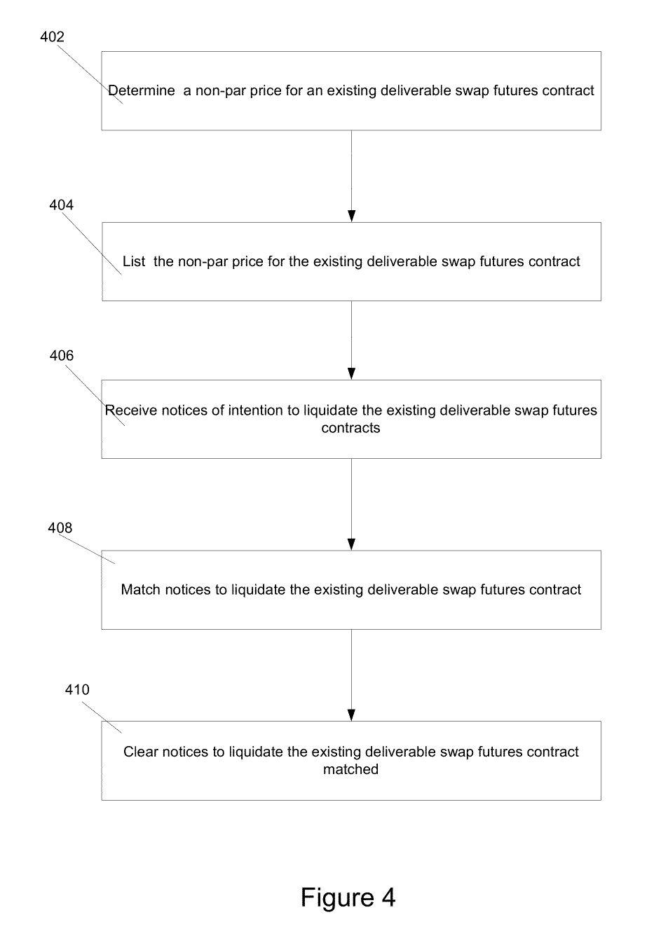

FIG. 4 illustrates a method of processing deliverable swap futures contracts in accordance with an embodiment of the invention. The process shown in FIG. 4 may be implemented with one or more exchange computer systems or one or more computer systems operated by another entity. First, in step 402 a non-par price is determined for an existing deliverable swap futures contract. The existing deliverable swap futures contract may be a deliverable interest rate swap futures contract and the non-par price may be determined with the processes described above. Next, in step 404 the non-par price for the existing deliverable swap futures contract is listed. Step 404 may include an exchange or other entity publishing or otherwise distributing the price. An exchange or other entity may receive notices of intention to liquidate existing deliverable swap futures contracts in step 406. Notices may be matched in step 408. Step 408 may include considering any additional monetary consideration included in notices of intention to liquidate. After notices are matched, matched notices may be cleared in step 410.

In alternative embodiments of the invention, traders may use a request for quote process for liquidating existing deliverable swap futures contracts. Traders may review prices published by an exchange or other entity and submit notices of intention to liquidate in the form of requests for quote.

The present invention has been described herein with reference to specific exemplary embodiments thereof. It will be apparent to those skilled in the art, that a person understanding this invention may conceive of changes or other embodiments or variations, which utilize the principles of this invention without departing from the broader spirit and scope of the invention as set forth in the appended claims. All are considered within the sphere, spirit, and scope of the invention.

What is claimed is:

1. A method of processing deliverable swap futures contracts comprising:
(a) determining by an exchange computer device a non-par price for an existing deliverable swap futures contract;
(b) listing at an exchange the non-par price for the existing deliverable swap futures contract;
(c) receiving at the exchange notices of intention to liquidate the existing deliverable swap futures contract; and
(d) matching at an exchange computer device notices to liquidate the existing deliverable swap futures contract.

2. The method of claim 1, wherein the existing deliverable swap futures contract comprises an existing deliverable interest rate swap futures contract and (a) comprises:
determining a difference between a present value of a floating rate component and a present value of a fixed rate component.

3. The method of claim 2, wherein an interest rate used to determine the present value of a floating rate component is selected by an exchange.

4. The method of claim 3, wherein the interest rate selected is selected based on prevailing market conditions.

5. The method of claim 4, wherein the interest rate selected is selected based on a published Eurodollar forward yield curve.

6. The method of claim 1, wherein (c) comprises:
receiving a notice of intention to liquidate an existing deliverable swap futures contract and an identification of monetary consideration in addition to the non-par price.

7. The method of claim 1, further including:
(e) clearing notices to liquidate the existing deliverable swap futures contract matched in (d).

8. The method of claim 7, wherein (e) comprises a novation via an automated book entry.

9. A computer system comprising:
at least one processor;
a tangible computer-readable memory containing computer-executable instructions that when executed by the at least one processor cause the computer system to perform the steps comprising:
(a) determining a non-par price for an existing deliverable swap futures contract;
(b) listing the non-par price for the existing deliverable swap futures contract;
(c) receiving notices of intention to liquidate the existing deliverable swap futures contract; and
(d) matching notices to liquidate the existing deliverable swap futures contract.

10. The computer system of claim 9, wherein (a) comprises:
determining a difference between a present value of a floating rate component and a present value of a fixed rate component.

11. The computer system of claim 10, wherein an interest rate used to determine the present value of a floating rate component is selected by an exchange.

12. The computer system of claim 11, wherein the interest rate selected is selected based on prevailing market conditions.

13. The computer system of claim 12, wherein the interest rate selected is selected based on a published Eurodollar forward yield curve.

14. The computer system of claim 9, wherein (c) comprises:
receiving a notice of intention to liquidate an existing deliverable swap futures contract and an identification of monetary consideration in addition to the non-par price.

15. The computer system of claim 9, further including:
(e) clearing notices to liquidate the existing deliverable swap futures contract matched in (d).

16. The computer system of claim 15, wherein (e) comprises a novation via an automated book entry.

17. The computer system of claim 9, wherein the at least at least one processor is part of an exchange computer system.

18. A tangible computer-readable medium containing computer-executable instructions that when executed by at least one processor cause a computer system to perform the steps comprising:
(a) determining a non-par price for an existing deliverable swap futures contract;
(b) listing the non-par price for the existing deliverable swap futures contract;
(c) receiving notices of intention to liquidate the existing deliverable swap futures contract; and
(d) matching notices to liquidate the existing deliverable swap futures contract.

19. The tangible computer-readable medium of claim 18, wherein the existing deliverable swap futures contract comprises an existing deliverable interest rate swap futures contract and (a) comprises:
determining a difference between a present value of a floating rate component and a present value of a fixed rate component.

20. The tangible computer-readable medium of claim 19, wherein an interest rate used to determine the present value of a floating rate component is selected by an exchange.
